(19) United States
(12) Patent Application Publication
(10) Pub. No.: US 2025/0128771 A1
(43) Pub. Date: Apr. 24, 2025

(54) VEHICLE BODY PART AND VEHICLE BODY ASSEMBLY STRUCTURE THEREOF

(71) Applicants: Hyundai Motor Company, Seoul (KR); Kia Corporation, Seoul (KR)

(72) Inventor: ChangHak Kang, Hwaseong-si (KR)

(21) Appl. No.: 18/817,430

(22) Filed: Aug. 28, 2024

(30) Foreign Application Priority Data
Oct. 19, 2023 (KR) 10-2023-0140590

(51) Int. Cl. B62D 27/06; B62D 65/02; F16B 5/02; F16B 35/04

(52) U.S. Cl. CPC B62D 27/065; F16B 5/025; F16B 35/041; B62D 65/024

(57) ABSTRACT

An embodiment vehicle body part includes a panel, a centering cap bolt mounted on the panel and having a screw thread on an exterior circumference surface, and a centering pin that is detachably provided with the centering cap bolt and is insertable together with the centering cap bolt into a centering hole disposed in a vehicle body.

### CROSS-REFERENCE TO RELATED APPLICATIONS

This application claims the benefit of Korean Patent Application No. 10-2023-0140590, filed on Oct. 19, 2023, which application is hereby incorporated herein by reference.

### TECHNICAL FIELD

The present invention relates to a vehicle body part and a vehicle body assembly structure thereof.

### BACKGROUND

Recently, the vehicle industry is introducing a new concept of future mobility vision for realizing a human-centered, dynamic future city. One of these future mobility solutions is a purpose built vehicle (PBV) as a purpose-based mobility.

A PBV can be an example of an electric vehicle (EV)-based environment-friendly mobile vehicle. The PBV can provide various customized services to users while moving from the starting point to the destination in an unmanned autonomous driving method.

The PBV's body may be manufactured in various shapes and sizes depending on the user's use case. For example, the vehicle body of a PBV may be used as a hailing or delivery type vehicle.

Various vehicle body parts (e.g., panel parts) are mounted on the vehicle body of this PBV. Vehicle body parts may be mounted on the vehicle body by a fastening member including a combination of bolts and nuts.

In one example, in order to provide the user with a wide interior space of the PBV, a roof assembly to which a large area roof panel is applied may be mounted on the vehicle body.

In another example, in order to provide the user with a feeling of open interior of the PBV, a roof assembly with roof glass (e.g., sunroof glass) mounted on the roof panel may be mounted on the vehicle body.

In another example, a roof assembly in which various operating systems of the PBV (e.g., autonomous driving sensor module, air conditioning module, solar cell module, etc.) are mounted on the roof panel may be mounted on the vehicle body.

In the process of assembling the vehicle body parts as described above into the vehicle body, the centering of the vehicle body parts and the vehicle body is not aligned due to the size and weight of the vehicle body parts, and the vehicle body parts may be incorrectly installed at the set centering position of the vehicle body.

In this way, if the vehicle body parts are assembled into the vehicle body without the centering of the vehicle body being aligned, watertightness, NVH, and durability problems may occur.

Matters described in this background section are prepared to enhance understanding of the background of embodiments of the invention and may include matters other than the already known art.

### SUMMARY

The present invention relates to a vehicle body part and a vehicle body assembly structure thereof. Particular embodiments relate to a vehicle body part and a vehicle body assembly structure capable of centering function and mounting for the vehicle body.

Embodiments of the present disclosure provide a vehicle body part and a vehicle body assembly structure that may implement the centering function and mounting of the part to the vehicle body.

A vehicle body part according to an exemplary embodiment may include at least one centering cap bolt mounted on the panel and having a screw thread on an exterior circumference side, and a centering pin that is detachably provided with the centering cap bolt and is inserted with the centering cap bolt into a centering hole formed in a vehicle body.

The vehicle body part may further include a mounting bracket connected to the panel and onto which the centering cap bolt is mounted.

The centering cap bolt may include a head part and a shank portion connected to the head part having a pipe-shaped hollow shape.

The screw thread may be formed on an exterior circumference of the shank portion.

The centering pin may be joined by an interference fit in the hollow of the shank portion.

The centering pin may include a fitting portion inserted into the hollow and a pin body that is connected and extends from the fitting portion with an exterior diameter d2 that is larger than an exterior diameter d1 of the fitting portion.

The exterior diameter d2 of the pin body, an exterior diameter d3 of the shank portion, and a diameter d4 of the centering hole may satisfy d3≤d2<d4.

The centering pin may further include at least one rib formed along the exterior circumference direction on the exterior diameter of the fitting portion.

An exterior diameter d5 of the at least one rib may be larger than the exterior diameter d1 of the fitting portion and may be equal to or larger than an interior diameter d6 of the shank portion.

The centering pin may be separated from the centering cap bolt after being inserted into the centering hole.

A vehicle body assemble structure of the vehicle body part according to an exemplary embodiment may include a nut fastened to the thread of the centering cap bolt that is inserted into the centering hole.

The centering cap bolt may include a head part and a shank portion connected to the head part and having a pipe-shaped hollow shape.

The vehicle body assemble structure may further include a mounting bracket connected to the panel and onto which the centering cap bolt is mounted.

The vehicle body part may be a roof assembly.

The centering cap bolt may be connected to the centering hole formed in a roof rail of the vehicle body.

According to the vehicle body part and the vehicle body assembly structure according to an exemplary embodiment, the watertight performance, NVH performance, durability, assemblability, and productivity of the vehicle body may be increased, and it is advantageous in terms of manufacturing cost and weight reduction of the PBV.

In addition, the effects that can be obtained or predicted from an exemplary embodiment will be disclosed directly or implicitly in the detailed description of the embodiments of the present invention. That is, various effects expected according to embodiments of the present invention will be disclosed in the detailed description to be described later.

### BRIEF DESCRIPTION OF THE DRAWINGS

Since these drawings are for reference in explaining exemplary embodiments of the present invention, the technical ideas of the present invention should not be interpreted as limited to the attached drawings.

FIG. 1 is a side view showing a vehicle body part according to an exemplary embodiment.

FIG. 2 is a perspective view showing a vehicle body part according to an exemplary embodiment.

FIG. 3 is an exploded perspective view showing a vehicle body part according to an exemplary embodiment.

FIG. 4 is a cross-sectional view showing a vehicle body part according to an exemplary embodiment.

FIG. 5 is an exploded sectional view showing a vehicle body part according to an exemplary embodiment.

FIG. 6 to FIG. 10 are cross-sectional views to explain the vehicle body assemble method of a vehicle body part according to an exemplary embodiment.

The following reference identifiers may be used in connection with the drawings to describe various features of embodiments of the present invention.

| | |
|---|---|
| 10: vehicle body | 11: centering hole |
| 13: roof rail | 20: roof assembly |
| 21: panel | 31: centering cap bolt |
| 33: head part | 35: shank portion |
| 37: hollow | 39: screw thread |
| 41: mounting bracket | 71: centering pin |
| 73: fitting portion | 75: pin body |
| 77: guiding portion | 79: rib |
| 90: nut | 100: vehicle body part |
| 200: vehicle body assemble structure | |

The drawings referenced above are not necessarily drawn to scale and should be understood as presenting a rather simplified representation of various preferred features illustrating the basic principles of embodiments of the invention. The specific design features of embodiments of the invention, including, for example, specific dimensions, orientations, locations, and shapes, will be determined in part by the particular intended application and usage environment.

### DETAILED DESCRIPTION OF ILLUSTRATIVE EMBODIMENTS

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The terminology used herein is for the purpose of describing specific embodiments only and is not intended to limit the disclosure. As used herein, singular forms are intended to also include plural forms, unless the context clearly indicates otherwise.

As used herein, the terms ‘comprise’ and/or ‘comprising’ indicate the presence of specified features, integers, steps, operations, elements, and/or components, but they may also include one or more other features, integers, or steps. It should also be understood that this does not exclude the presence or addition of elements, operations, components, and/or groups thereof.

As used herein, the term ‘and/or’ includes any one or all combinations of one or more items listed in association.

In this specification, the term ‘connected’ or ‘combined’ indicates a physical relationship between two components in which the components are directly connected to each other by welding, rivets, self piercing rivet (SPR), flow drill screw (FDS), structural adhesive, etc., or indirectly connected through one or more intermediate components.

As used herein, ‘vehicle,’ ‘vehicular,’ ‘automotive,’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs, hydrogen-powered vehicles, and other alternative fuel vehicles (e.g., other than petroleum fuel derived from resources).

Hereinafter, embodiments of the present invention will be described in detail with reference to the accompanying drawings.

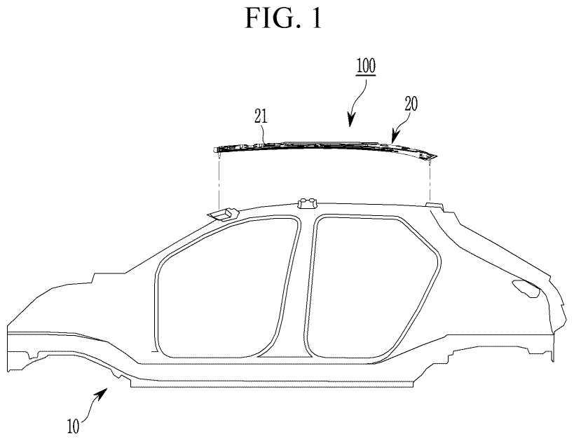

FIG. 1 is a side view showing a vehicle body part according to an exemplary embodiment.

Referring to FIG. 1, a vehicle body 10, to which a vehicle body part 100 according to an exemplary embodiment may be applied, for example, may be applied to a purpose built vehicle (hereinafter referred to as ‘PBV’).

The PBV may be used as an electric vehicle-based life module vehicle that provides various customized services to users during the travel time from the origin to the destination.

In one example, the PBV may be manufactured in a one box type design with a large interior space. The PBV may also apply facing type seats to the interior space.

The vehicle body of such a PBV is suitable for small quantity production of various vehicle types with a small number of parts and may be manufactured in various shapes and sizes. Various vehicle types may include, for example, a hailing vehicle for transporting occupants, a delivery vehicle for transporting goods, and special vehicles such as an ambulance.

A vehicle body part 100 according to an exemplary embodiment may be mounted on the vehicle body 10 of the PBV. The vehicle body part 100 according to an exemplary embodiment may include, for example, a roof assembly 20 mounted on an upper part of the vehicle body 10.

Here, in one example, the roof assembly 20 may include a large-area panel 21. And, in another example, the roof assembly 20 may be a roof module on which a roof glass (not shown) is mounted on the panel 21. In another example, the roof assembly 20 may be a roof module on which various operation systems (not shown) of the PBV are mounted on the panel 21.

The various operating systems of the PBV may include, for example, an autonomous driving sensor module, an air conditioning module, a solar cell module, and so on.

The vehicle body part 100 according to an exemplary embodiment of the present invention may be mounted on the upper part of the vehicle body 10 by a fastening member including a combination of bolts and nuts.

However, the vehicle body part 100 according to an exemplary embodiment is not limited to including the roof assembly 20 as described above, and it may include other vehicle body parts that can be assembled into the vehicle body 10.

In this specification, the ‘front to rear direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

In this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The vehicle body part 100 according to an exemplary embodiment may be applied to a structure capable of a centering function and mounting for the vehicle body 10.

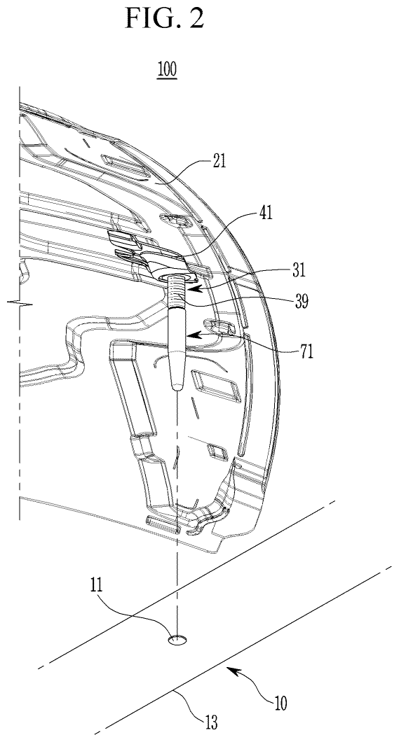

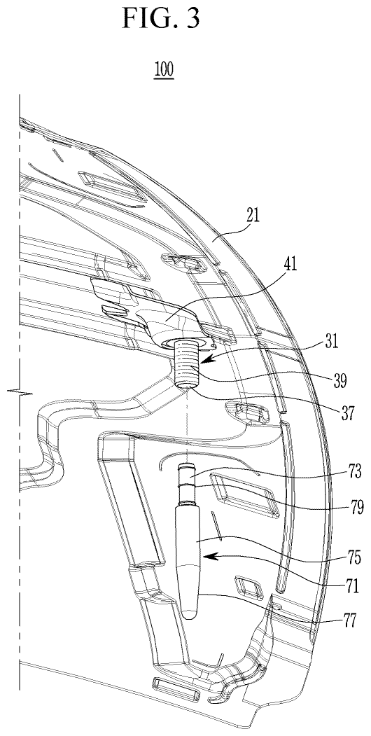

FIG. 2 is a perspective view showing a vehicle body part according to an exemplary embodiment, and FIG. 3 is an exploded perspective view showing a vehicle body part according to an exemplary embodiment.

Referring to FIG. 1 to FIG. 3, the vehicle body part 100 according to an exemplary embodiment may include a panel 21, at least one centering cap bolt 31, and a centering pin 71.

In an exemplary embodiment, the panel 21 may be provided as a vehicle body panel with a predetermined area.

In one example, the panel 21 may include a roof panel coupled to the upper part of the vehicle body 10, but it is not limited thereto and may also include a panel mounted other than to the upper part of the vehicle body 10.

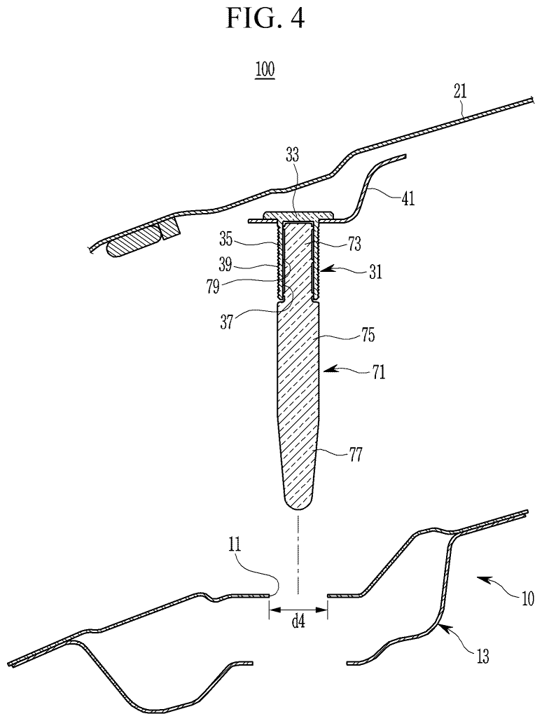

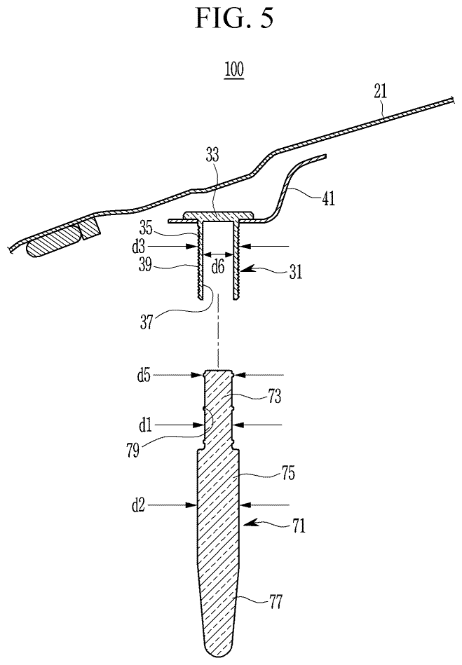

FIG. 4 is a cross-sectional view showing a vehicle body part according to an exemplary embodiment, and FIG. 5 is an exploded sectional view showing a vehicle body part according to an exemplary embodiment.

Referring to FIG. 1 to FIG. 5, in an exemplary embodiment, the centering cap bolt 31 is configured to center the top of the vehicle body 10 and the panel 21 and to mount the panel 21 on the upper part of the vehicle body 10.

In one example, the centering cap bolt 31 may be placed in the front-to-back direction or the width direction of the vehicle body of the panel 21. The centering cap bolt 31 is mounted on the lower part of the panel 21 based on the drawing.

Furthermore, the centering cap bolt 31 may be mounted on a mounting bracket 41 connected to the lower side of the panel 21.

The mounting bracket 41 may be connected to the lower side of the panel 21 by welding. Additionally, the centering cap bolt 31 may be inserted into the mounting bracket 41 in the vertical direction and be coupled to the upper surface of the mounting bracket 41 by welding.

This centering cap bolt 31 includes a head part 33 and a shank portion 35.

The head part 33 may be formed into a disk shape with a predetermined exterior diameter. The head part 33 is coupled to the upper side of the mounting bracket 41.

The shank portion 35 extends from the lower side of the head part 33 in the downward direction based on the drawing. The shank portion 35 may be formed in the form of a hollow shaft with a hollow 37 (e.g., pipe shape).

The shank portion 35 is inserted into the mounting bracket 41 in a vertical direction, and the head part 33 supports the upper surface of the mounting bracket 41 and may be joined to the upper surface by welding.

The shank portion 35 may be inserted into a centering hole 11 formed in the vehicle body 10 along the vertical direction. A screw thread 39 is formed on an exterior circumference surface of the shank portion 35.

In one example, the centering hole 11 of the vehicle body 10 may be formed on a roof rail 13 disposed along the vehicle width direction on the top of the vehicle body 10.

In an exemplary embodiment, the centering pin 71 is inserted into the centering hole 11 of the vehicle body 10 together with the centering cap bolt 31 and is configured to align the centering of the upper part of the vehicle body 10 and the panel 21.

The centering pin 71 is removable from the centering cap bolt 31. The centering pin 71 is provided in the form of a solid shaft and may be inserted into the centering hole 11 of the vehicle body 10 together with the centering cap bolt 31.

The centering pin 71 may include a fitting portion 73, a pin body 75, a guiding portion 77, and at least one rib 79.

The fitting portion 73 is removably provided on the shank portion 35 of the centering cap bolt 31. The fitting portion 73 is inserted into the hollow 37 of the shank portion 35 and may be separated from the hollow 37. The fitting portion 73 may be coupled to the hollow 37 of the shank portion 35 through interference fit.

The pin body 75 has an exterior diameter d2 larger than an exterior diameter d1 of the fitting portion 73 and extends in the downward direction based on the drawing in the fitting portion 73.

Here, the exterior diameter d2 of the pin body 75, an exterior diameter d3 of the shank portion 35, and a diameter d4 of the centering hole 11 may satisfy d3≤d2<d4.

The guiding portion 77 is configured to guide the pin body 75 to the centering hole 11 of the vehicle body 10. The guiding portion 77 extends from the pin body 75 in a downward direction with an exterior diameter that gradually becomes smaller.

In addition, the at least one rib 79 is configured to easily connect the fitting portion 73 to the hollow 37 of the shank portion 35 through interference fit. The rib 79 may be in close contact with the interior diameter of the shank portion 35.

The rib 79 is formed along the exterior circumference direction on the exterior diameter surface of the fitting portion 73. In other words, the rib 79 is formed to protrude in the outer direction of the exterior circumference on the exterior diameter of the fitting portion 73. In the drawing, the ribs 79 are shown as three formed on the exterior diameter of the fitting portion 73, but the design is not limited to this.

An outer diameter d5 of the rib 79 is larger than the outer diameter d1 of the fitting portion 73 and is equal to or larger than an inner diameter d6 of the shank portion 35.

As a result, the rib 79 is connected to the shank portion 35 with a tight fitting, and the centering pin 71 is inserted into the centering hole 11 of the vehicle body 10 together with the centering cap bolt 31. And the rib 79 prevents the centering pin 71 from separating from the centering cap bolt 31 while centering the vehicle body 10 and the panel 21.

The centering pin 71 according to an exemplary embodiment of the present invention is coupled to the shank portion 35 of the centering cap bolt 31 through the fitting portion 73, is inserted with the shank portion 35 into the centering hole 11 of the vehicle body 10 to align the vehicle body 10 and the panel 21, and the centering pin 71 may be separated from the shank portion 35.

Hereinafter, the vehicle body assemble structure and method of the vehicle body part 100 according to an exemplary embodiment configured as described above will be described in detail.

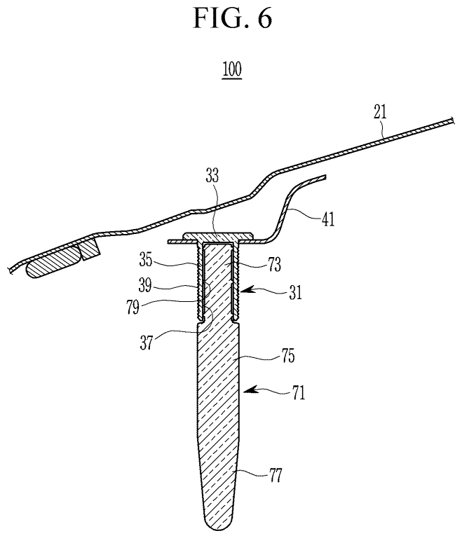

FIG. 6 to FIG. 10 are cross-sectional views to explain the vehicle body assemble method of a vehicle body part according to an exemplary embodiment.

Referring to FIG. 6, the vehicle body part 100 according to an exemplary embodiment is provided.

The vehicle body part 100 according to an exemplary embodiment includes the centering cap bolt 31 mounted on the lower surface of the panel 21 and the centering pin 71 coupled to the centering cap bolt 31.

The centering cap bolt 31 is mounted on the mounting bracket 41 attached to the lower side of the panel 21. The centering cap bolt 31 includes the head part 33 and the shank portion 35. And, the centering pin 71 includes the fitting portion 73, the pin body 75, the guiding portion 77, and at least one rib 79.

The centering pin 71 is inserted into the hollow 37 of the shank portion 35 through the fitting portion 73. The fitting portion 73 may be joined by an interference fit to the hollow 37 of the shank portion 35 by the rib 79.

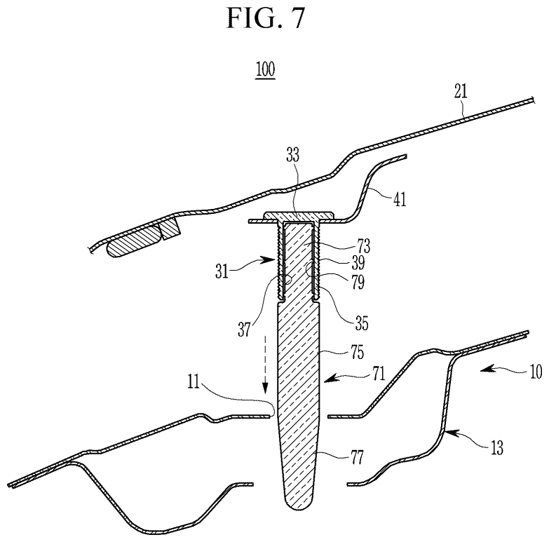

As shown in FIG. 7, the vehicle body part 100 according to an exemplary embodiment as described above is positioned on the upper side of the vehicle body 10 and is moved downward. Then, the guiding portion 77 of the centering pin 71 is inserted into the centering hole 11 of the vehicle body 10.

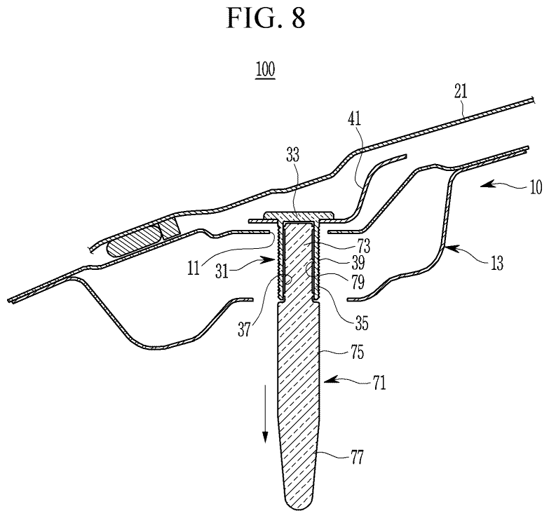

As shown in FIG. 8, the pin body 75 of the centering pin 71 is guided to the centering hole 11 by the guiding portion 77 and is inserted into the centering hole 11 together with the shank portion 35 of the centering cap bolt 31.

Since the exterior diameter d2 of the pin body 75, the exterior diameter d3 of the shank portion 35, and the diameter d4 of the centering hole 11 satisfy d3≤d2<d4, the centering cap bolt 31 and the centering pin 71 may easily fit into the centering hole 11.

Accordingly, the vehicle body part 100 according to an exemplary embodiment is centered with the vehicle body 10 and is positioned at the top of the roof rail 13 at a predetermined position above the vehicle body 10.

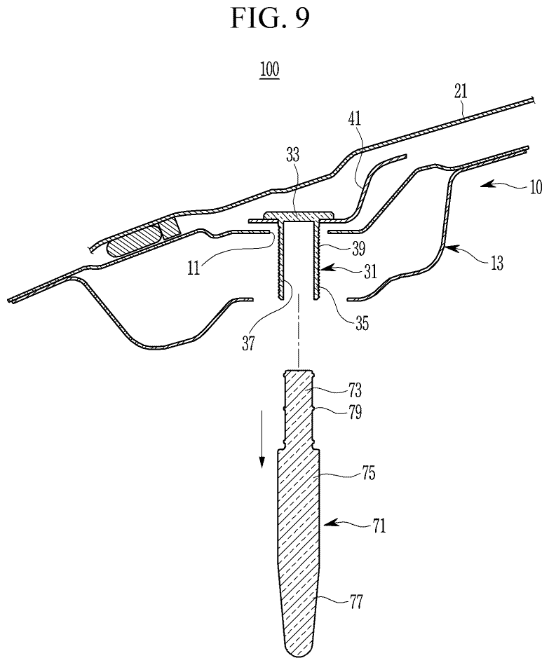

As shown in FIG. 9, after the centering cap bolt 31 and the centering pin 71 are coupled to the centering hole 11, the centering pin 71 is separated from the shank portion 35 of the centering cap bolt 31.

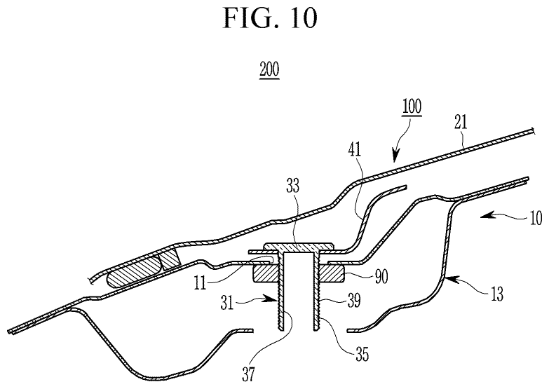

As shown in FIG. 10, then, the nut 90 is engaged with the screw thread 39 formed on the exterior circumference of the shank portion 35. Then, the vehicle body part 100 according to an exemplary embodiment is mounted at a predetermined position at the top of the vehicle body 10, for example, on the roof rail 13.

As described above, according to the vehicle body assembly structure 200 of the vehicle body part 100 assembled to the vehicle body 10 according to an embodiment of the present invention, the shank portion 35 of the centering cap bolt 31 mounted on the panel 21 is coupled to the centering hole 11 of the vehicle body 10.

The head part 33 of the centering cap bolt 31 is coupled to the mounting bracket 41 mounted on the lower side of the panel 21.

And, the shank portion 35 is coupled to the centering hole 11 of the vehicle body 10, so that the centering with the vehicle body 10 is maintained.

In this state, the nut 90 is engaged with the screw thread 39 of the shank portion 35 that is inserted into the centering hole 11.

According to the vehicle body part 100 and the vehicle body assemble structure 200 according to an exemplary embodiment as described so far, the vehicle body part 100 and the vehicle body 10 are connected by the centering cap bolt 31 and the centering pin 71 inserted into the centering hole 11 of the vehicle body 10 while the centering of vehicle body 10 and the vehicle body part 100 is adjusted.

In addition, according to the vehicle body part 100 and the vehicle body assemble structure 200 according to an exemplary embodiment, at the centering position of the vehicle body part 100 and the vehicle body 10, the vehicle body part 100 can be mounted on the vehicle body 10 by the nut 90 that is engaged with the centering cap bolt 31.

Therefore, according to the vehicle body part 100 and the vehicle body assemble structure 200 according to an exemplary embodiment, it is possible to prevent the vehicle body part 100 from being mounted on the vehicle body 10 when the centering of the vehicle body part 100 and the vehicle body 10 are not aligned.

Accordingly, according to the vehicle body part 100 and the vehicle body assemble structure 200 according to an exemplary embodiment, mis-assembly of the vehicle body part 100 and the vehicle body 10 can be prevented, and the watertight performance and durability of the vehicle can be increased.

In addition, according to the vehicle body part 100 and the vehicle body assemble structure 200 according to an exemplary embodiment, the centering of the vehicle body part 100 and the vehicle body 10 can be aligned with a simple configuration, so the assemblability and productivity of the vehicle can be improved.

Furthermore, according to the vehicle body part 100 and the vehicle body assemble structure 200 according to an exemplary embodiment, because centering and mounting of the vehicle body part 100 and the vehicle body 10 can be implemented simultaneously, it is advantageous in terms of vehicle NVH performance, manufacturing cost, and weight reduction.

While embodiments of this invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A vehicle body part comprising:
a panel;
a centering cap bolt mounted on the panel and having a screw thread on an exterior circumference surface; and
a centering pin that is detachably provided with the centering cap bolt and is insertable together with the centering cap bolt into a centering hole disposed in a vehicle body.

2. The vehicle body part of claim 1, further comprising a mounting bracket connected to the panel, wherein the centering cap bolt is mounted on the mounting bracket.

3. The vehicle body part of claim 1, wherein the centering cap bolt comprises:
a head part; and
a shank portion connected to the head part and having a pipe-shaped hollow region.

4. The vehicle body part of claim 3, wherein the screw thread is on an exterior circumference of the shank portion.

5. The vehicle body part of claim 3, wherein the centering pin is joined by an interference fit in the hollow region of the shank portion.

6. The vehicle body part of claim 3, wherein the centering pin comprises:
a fitting portion inserted into the hollow region, the fitting portion having an exterior diameter d1; and
a pin body that is connected to and extends from the fitting portion, the pin body having an exterior diameter d2 that is larger than the exterior diameter d1 of the fitting portion.

7. The vehicle body part of claim 6, wherein the exterior diameter d2 of the pin body, an exterior diameter d3 of the shank portion, and a diameter d4 of the centering hole satisfy d3≤d2<d4.

8. The vehicle body part of claim 6, wherein the centering pin further comprises a rib disposed along an exterior circumference direction on the exterior diameter d1 of the fitting portion.

9. The vehicle body part of claim 8, wherein an exterior diameter d5 of the rib is larger than the exterior diameter d1 of the fitting portion and is equal to or larger than an interior diameter d6 of the shank portion.

10. The vehicle body part of claim 8, wherein the centering pin is separated from the centering cap bolt after being inserted into the centering hole.

11. A vehicle body assemble structure comprising:
a vehicle body part comprising:
a panel;
a centering cap bolt mounted on the panel and having a screw thread on an exterior circumference surface; and
a centering pin that is detachably provided with the centering cap bolt and is inserted with the centering cap bolt into a centering hole disposed in a vehicle body; and
a nut fastened to the screw thread of the centering cap bolt that is inserted into the centering hole.

12. The vehicle body assemble structure of claim 11, wherein the centering cap bolt comprises:
a head part; and
a shank portion connected to the head part and having a pipe-shaped hollow region.

13. The vehicle body assemble structure of claim 12, wherein the screw thread is on an exterior circumference of the shank portion.

14. The vehicle body assemble structure of claim 12, wherein the centering pin is joined by an interference fit in the hollow region of the shank portion.

15. The vehicle body assemble structure of claim 12, wherein the centering pin comprises:
a fitting portion inserted into the hollow region, the fitting portion having an exterior diameter d1; and
a pin body that is connected to and extends from the fitting portion, the pin body having an exterior diameter d2 that is larger than the exterior diameter d1 of the fitting portion.

16. The vehicle body part of claim 15, wherein the exterior diameter d2 of the pin body, an exterior diameter d3 of the shank portion, and a diameter d4 of the centering hole satisfy d3≤d2<d4.

17. The vehicle body part of claim 15, wherein the centering pin further comprises a rib disposed along an exterior circumference direction on the exterior diameter d1 of the fitting portion, and wherein an exterior diameter d5 of the rib is larger than the exterior diameter d1 of the fitting portion and is equal to or larger than an interior diameter d6 of the shank portion.

18. The vehicle body assemble structure of claim 11, further comprising a mounting bracket connected to the panel, wherein the centering cap bolt is mounted on the mounting bracket.

19. The vehicle body assemble structure of claim 11, wherein the vehicle body part comprises a roof assembly.

20. The vehicle body assemble structure of claim 11, wherein the centering cap bolt is connected to the centering hole, and wherein the centering hole is disposed in a roof rail of the vehicle body.
